(19) United States
(12) Patent Application Publication
(10) Pub. No.: US 2002/0014427 A1
(43) Pub. Date: Feb. 7, 2002

(54) Plate-shaped flower carrier

(75) Inventors: Cornelis J. van der Stoep, Bergschenhoek (NL); Iris C. Braxhoofden-van der Heide, Den Haag (NL); Casper Kleiman, Alkmaar (NL); Jeroen K. Verbrugge, Hoek Van Holland (NL); Jacob Struijk, Bergschenhoek (NL)

Correspondence Address: OSTROLENK FABER GERB & SOFFEN, 1180 AVENUE OF THE AMERICAS, NEW YORK, NY, 100368403

(73) Assignee: Cornelis J. van der Stoep

(21) Appl. No.: 09/911,208

(22) Filed: Jul. 23, 2001

(30) Foreign Application Priority Data
Jul. 31, 2000 (NL) 1015844

(51) Int. Cl. B65D 85/52; A01G 9/02

(52) U.S. Cl. 206/423; 47/84; 47/85

(57) ABSTRACT

The invention relates to a plate-shaped carrier for flowers, having in its plane a number of accommodating openings for the respective flower stems, comprising, for easing the insertion of the respective flower stems in an accommodating opening, a flower stem infeed slot, starting from a longitudinal edge of the carrier and running downwardly under an acute angle with this edge into the accommodating opening.

### BACKGROUND OF THE INVENTION

The invention relates to a plate-shaped flower carrier with in the plane thereof a number of accommodating openings for accommodating the respective flower stems.

### DESCRIPTION OF THE PRIOR ART

Such plate-shaped carriers are known from practice. A particular embodiment thereof, in which a number of such carriers abut each other and are combined to an in cross-section polygonal sleeve is subject of the Dutch patent specification 1002176, while another embodiment thereof, particularly destined to be housed in a special packing box, is described in the U.S. Pat. No. 5,217,117. Still another embodiment of such an elongate carrier is subject of the European patent application 0.395.827 A1 and this embodiment is destined to be combined with a special outer case.

All known plate-shaped carriers of this kind have the drawback that the respective flower stems, must be introduced therein via the infeed openings, which have an edge closed into itself. This is in itself a simple operation but, when this handling must be repeated a great number of times such as necessary for packing many flowers it is felt as being a nuisance and cumbersome, can result into RSI-complaints, and limits the speed with which carriers can be filled with flowers. Furthermore such a configuration is not suited for a mechanical introduction of the flower stems.

U.S. Pat. No. 2,474,543 shows a carrier for flowers, made up from plate-shaped material, having rectangular lips to be folded out of the plane of the carrier, each having a central take-up opening, and incisions running therefrom to the edge of the lip. This carrier is destined to combine into a “display” a number of flowers, each to be introduced into a supporting lip by moving the edges of the incision away from each other and forcing the stem through the thus obtained infeed slot. The underlying idea of the invention cannot be derived from this publication and it is not possible to obtain with this known carrier the aimed advantages.

### SUMMARY OF THE INVENTION

The invention aims to provide a carrier which obviates these drawbacks. According to the invention this is obtained in that a flower stem infeed slot, starting at a longitudinal side of the carrier and running downwardly under an acute angle with this side, opens into the infeed opening.

By this simple measure, which in no way increases the cost of the carriers, is obtained that it is not necessary anymore to introduce the flowers with the end of the stem thereof aimed at an opening, but must be slided from the side into the infeed channel. Practice has shown that this sliding motion can be effected much faster, much more accurate and with less manual action and less chance of damage than is possible with the way of insertion as done with the prior art. A mechanical infeed of the stems is simply possible as these stems must only be guided along the side of the carrier to the neighbourhood of an infeed slot.

A preferred configuration of the carrier is such that the edge boundary of an opening comprises a short stem supporting edge, running essentially crosswise to the longitudinal carrier axis and merging at each end into a diverging side edge boundary, including an acute angle with the longitudinal carrier axis, of which side edge boundaries one merges into the lower edge of the infeed slot and the other merges into the upper boundary of the opening.

In a preferred embodiment the stem supporting edge is formed by the folding edge of a stem supporting lip, cut out from the carried material and folded over to the backside of the carrier. With this measure it is obtained that the transition between flower head and stem is supported by a soft (folding) edge, having double the thickness of the carrier material while the supporting lip, which is folded over to the backside, engages resiliently the stem and prevents that an abrupt buckle is formed in the stem at the position of the transition to the flower head.

The edge boundaries are preferably constituted by the folding edge of a flower head supporting lip, cut out from the carrier material and bent over to the carrier backside. These two lips, folded to the backside, effect a supplementary support of the flower head, which thus cannot contact sharp edges of the carrier. When the stems are introduced mechanically they give a reliable guiding thereof.

When around each opening the contours of a flower to be supported therein are shown, sorting of the flowers during the packing as to their size is made easier. Of course the carrier can also carry other relevant information.

The invention also provides a sheet provided with folding lines and incisions to produce therefrom a carrier according to the invention comprising a number of sets of two converging incisions running from the carrier side under an acute angle with the longitudinal axis thereof and defining an infeed slot, of which the upper one merges into the convex upper edge of an incision bounding the accommodating opening, while from the respective ends thereof converging incisions run to the lower end of the carrier which define on the one hand the end edges of the stem supporting lip and on the other end the end edges of the two flower head supporting lips, as well as a U-shaped insert for a packing box to accommodate pair-wise carriers according to the invention, comprising locking lips protruding from the longitudinal middle of the bottom and from the opposite side walls for a locking cooperation with the longitudinal edges of the flower carriers accommodated in the box.

### DESCRIPTION OF THE DRAWINGS

FIG. 1 is a front view of part of a sheet from which a carrier of the invention is to be made;

FIG. 2 is a perspective front view of a carrier according to the invention;

FIG. 3 is a perspective rear view of such a carrier;

FIG. 4 is a perspective front view of a carrier according to the invention, provided with anthuriums;

FIG. 5 is a rear view on an enlarged scale of a part of a carrier according to the invention, provided with an anthurium;

FIG. 6 is a perspective upper view of a packing box with two inserts as proposed by to the invention and suitable for four carriers according to the invention;

FIG. 7 is a perspective view of an insert provided with locking lips to be used in the way as shown in FIG. 6;

FIG. 8 is a front view of a second embodiment according to the invention;

FIG. 9 is a front view of a third embodiment according to the invention.

### DESCRIPTION OF PREFERRED EMBODIMENTS

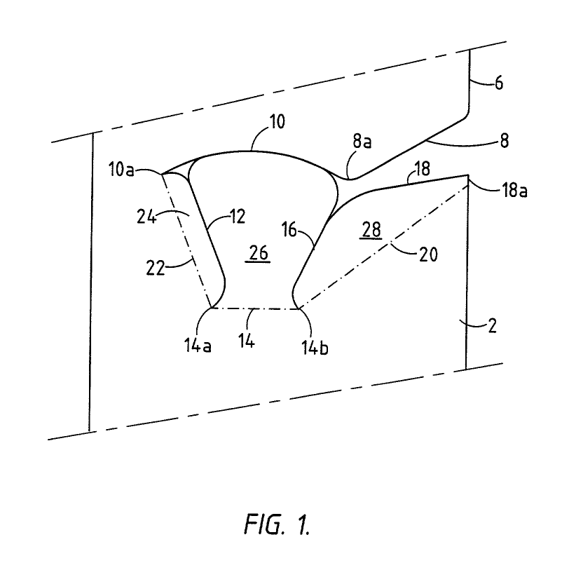

FIG. 1 shows a front view of part of a sheet 2, provided with incisions and folding edges from which is made the carrier to be described hereinafter; in fact the part in FIG. 1, which is denoted with reference numeral 2, is a part of a carrier which is denoted with reference numeral 4 in the other drawings. The sheet is preferably made up from thin corrugated cardboard which can easily be folded and then has a soft surface at the folding edge. From the right hand side 6 a first incision 8 runs downwardly which at its end 8a merges into a convex incision 10. From the left hand end 10a thereof an incision 12 runs under an acute angle with the longitudinal axis of the sheet 2 to the left edge 14a of a folding line 14, and from the right hand edge 14b thereof a second incision 16 starts, extending to the incision 10. This incision 16 merges into the incision 18 which runs to the right hand edge 6 and ends at a distance below the start of the incision 8. The meeting point 18a between this incision and the right hand side 6 is also the right hand end of a folding edge 20 of which the left hand end lies at pont 14b. A second folding line 22 runs between the left hand point 10a of the incision 10 and point 14a of incision 12.

Thus one obtains three lips which can be folded back: the first, left hand lip 24, the second central lip 26 and a third right hand lip 28. The central lip 26 is destined to be folded over 180 degrees to near the rear wall of the carrier which is made up from the sheet; the two other lips 24 and 28 at the respective sides thereof are destined to be bent over rearwardly over an obtuse angle.

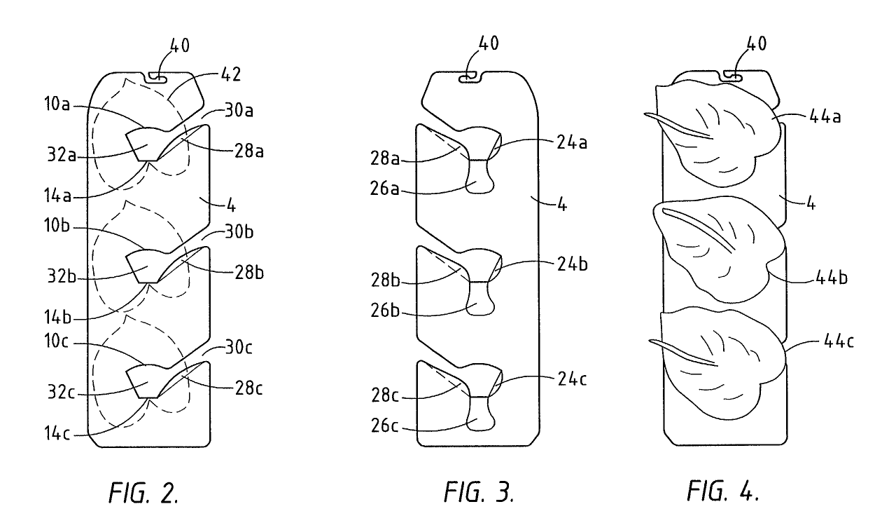

A sheet provided with a number—here three—incisions and folding lines as shown in FIG. 1 results into a carrier such as shown in FIG. 2 in perspecdtive front view and in FIG. 3 in perspective rear view. Such a carrier, indicated with reference numeral 4, comprises three stem infeed slots 30a, 30b, 30c respectively, each bounded by an incision 8 and a folding line 20, and a central stem accommodating opening 32a, 32b, 32c respectively, each bounded by, at the upper side, an incision 10a, 10b, 10c, and at the lower side a folding line 14a, 14b, 14c; and by upstanding boundaries which are made up by the folding lines 22 of the lips 24a-24c on the one hand and the edges of the lips 28a-28c on the other hand.

At the upper end of each carrier 4 there is a suitable cut-out 40 to support the carrier while preferably around the accommodating openings 32a, 32c the contours of the flower to be introduced in the carrier are shown; they are indicated with reference numeral 42.

FIG. 3 shows a rear view of a carrier 4 which is thus obtained, with the stem supporting lips 28a-28c, bent over over about 180 degrees and the folded lips 24a-24c and 28a-28c respectively.

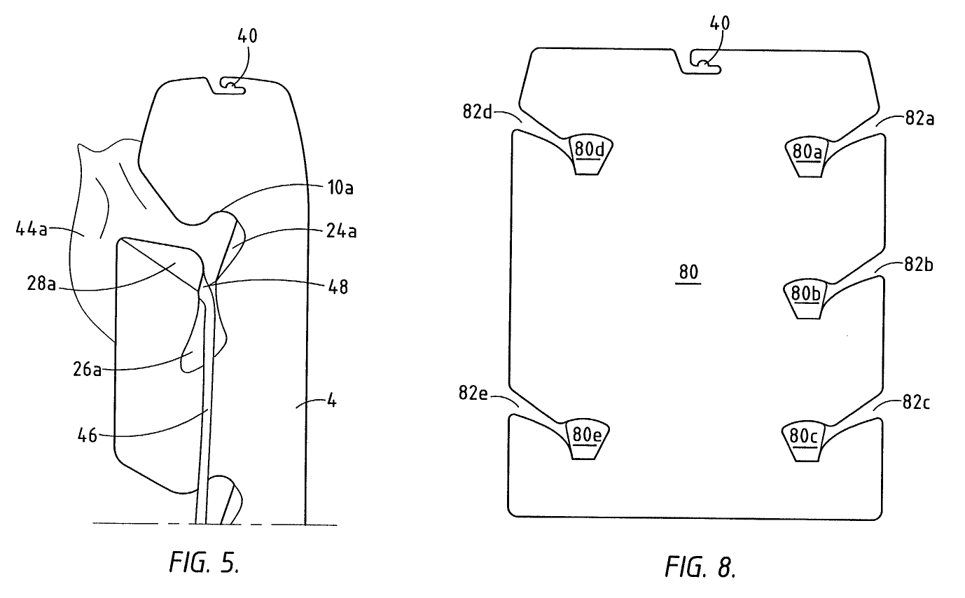

FIG. 4 shows a front view with a carrier 4 carrying three anthuriums 44a-44c while FIG. 5 shows on an enlarged scale a rear view of the upper part of a carrier 4 with the anthurium 44a. This figure shows clearly the lip 26a folded back over over 180 degrees, the backwardly folded supporting lips 24a and 28a respectively and the curved upper boundary 10a of the stem accommodating opening. The stem 46 is, at the position of the transition to the petal of anthurium 44a supported by the soft folding edge of the lip 26a which, by being resiliently urged away from the rear wall, prevents that an abrupt buckle in the stem is formed at this place.

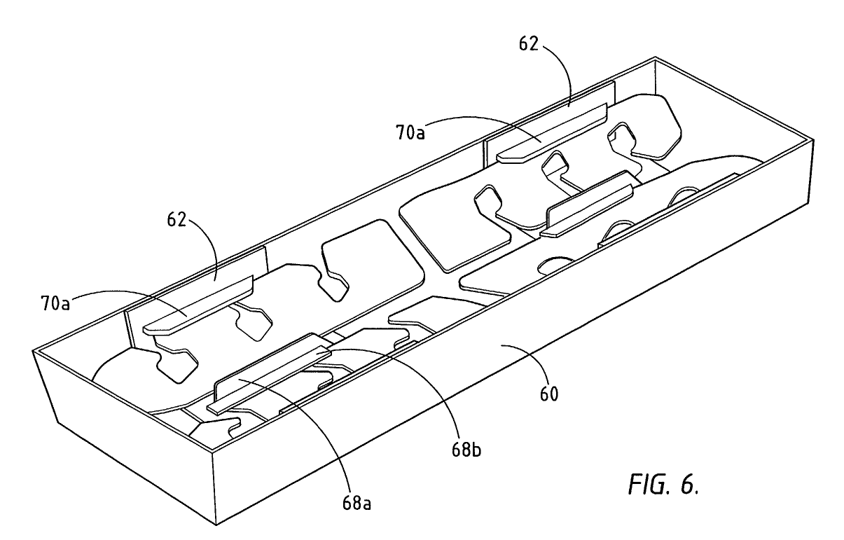

Anthuriums are preferably packed in predetermined numbers (depending upon their size) in elongate boxes, commonly made available by the auction hall. FIG. 6 shows in a perspective view such a box provided with inserts as proposed by the invention which keep the flower carriers in their correct position.

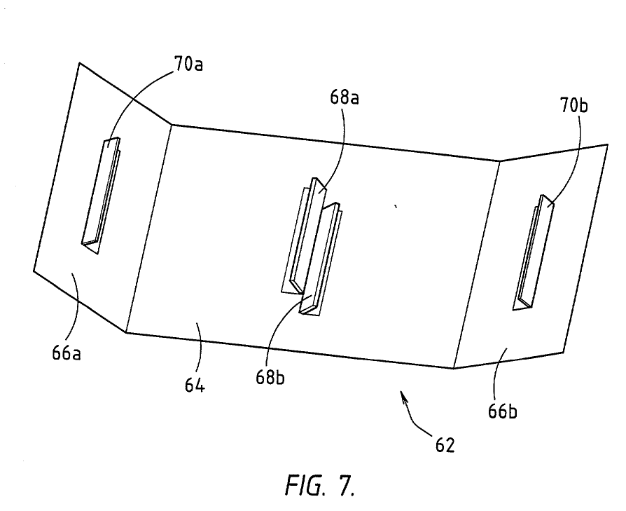

As in many cases an auction hall makes it obligatory to use a certain packing box, only available via this hall and which may not be modified, the invention proposes to provide a standard box 60 with two identical inserts 62 to keep flower carriers in their place in this box. FIG. 7 shows such an insert; it is indicated with reference numeral 62. The inserts comprise a bottom part 64 destined to lie against the bottom of the box 60 and is provided with upstanding walls 66a, 66b. The locking lips 68a, 68b are formed out of the bottom while from each of the upstanding parts 66a, 66b a locking lip 70a and 70b respectively is formed. For each box there are, as FIG. 6 shows, two of such inserts.

Of course the two inserts can also be combined into one single insert 72.

Many modifications are possible; for instance two carriers such as described hereinbefore can be combined into one single double carrier of which FIG. 8 shows an example. The symmetrical carrier 80 has at its right end edge three accommodating openings 80a-80c with infeed slots 82a-82c and at the left hand side two accommodating openings 80d-80e, with infeed slots 82d-82e.

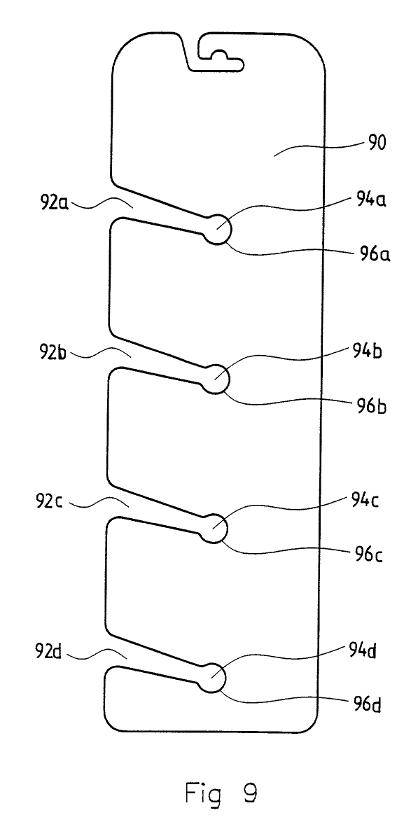

Finally FIG. 9 shows an embodiment of a carrier, denoted with numeral 90, and provided with a number of infeed slots 92a-92d which each end into an accommodating opening 94a-94d respectively, having circular boundaries 96a-96d respectively.

What is claimed is:

1. Plate-shaped flower carrier with in the plane thereof a number of accommodating openings for accommodating the respective flower stems, in which a flower stem infeed slot, starting at a longitudinal edge of the carrier and running downwardly under an acute angle with this edge, ends into an accommodating opening.

2. Carrier according to claim 1, comprising an accommodating opening with essentially circular boundaries.

3. Carrier according to claim 1, in which the edge boundary of an opening comprises a short stem supporting edge, running essentially crosswise to the longitudinal carrier axis and merging at each end into a diverging side edge boundary, including an acute angle with the longitudinal carrier axis, of which boundaries one merges into the lower edge of the infeed slot and the other merges into the upper boundary of the opening.

4. Carrier according to claim 3, in which the upper and lower edge of the infeed slot converge into the direction of the corresponding opening.

5. Carrier according to claim 1, in which the stem supporting edge is constituted by the folding edge of a stem supporting lip, cut out from the carrier material and folded over to the backside of the carrier.

6. Carrier according to claim 1, in which both the side-edge boundaries are constituted by the folding edge of a flower head supporting lip, cut out from the carrier material and folded over backwardly.

7. Carrier according to claim 1, in which around each opening the contours of a flower head to be accommodated therein are shown.

8. Sheet, provided with folding lines and incisions to construct therefrom an elongate flower carrier according to claim 5, and comprising a number of sets of two converging incisions running from the carrier side under an acute angle with the longitudinal axis thereof and defining an infeed slot, of which the upper one merges into the convex upper edge of an incision bounding the accommodating opening, while from the respective ends thereof converging incisions run to the lower end of the carrier which define on the one hand the end edges of the stem supporting lip and on the other end the end edges of the two flower head supporting lips.

9. U-shaped insert for a packing box to accommodate pair-wise carriers according to claim 1, comprising locking lips protruding from the longitudinal middle of the bottom and from the opposite side walls for a locking co-operation with the longitudinal edges of the flower carriers accommodated in the box.
